(19) United States
(12) Patent Application Publication
(10) Pub. No.: US 2026/0100796 A1
(43) Pub. Date: Apr. 9, 2026

(54) INDICATION OF UPLINK RESOURCE MUTING VIA SOUNDING REFERENCE SIGNAL

(71) Applicant: QUALCOMM Incorporated, San Diego, CA (US)

(72) Inventors: Muhammad Sayed Khairy ABDELGHAFFAR, San Jose, CA (US); Qian ZHANG, Basking Ridge, NJ (US)

(21) Appl. No.: 19/328,875

(22) Filed: Sep. 15, 2025

Related U.S. Application Data
(60) Provisional application No. 63/703,054, filed on Oct. 3, 2024.

(51) Int. Cl. H04L 5/00; H04W 72/044; H04W 72/21

(52) U.S. Cl. CPC H04L 5/0051; H04W 72/044; H04W 72/21

(57) ABSTRACT

Certain aspects of the present disclosure provide techniques for triggering muted resources according to sounding reference signal (SRS) allocations. A method generally includes obtaining a configuration for a set of SRS sets, the configuration comprising an indication of one or more SRS resources configured for at least one SRS set of the set of SRS sets; obtaining a grant for transmission of an uplink shared channel message; and sending the uplink shared channel message based at least in part on the grant, the uplink shared channel message comprising one or more muted resources that correspond to the one or more SRS resources based at least in part on the configuration.

### CROSS-REFERENCE TO RELATED APPLICATIONS

This Application claims the benefit of and priority to U.S. Provisional Patent Application No. 63/703,504, filed on Oct. 3, 2024, the entire contents of which are hereby incorporated by reference.

### INTRODUCTION

### Field of the Disclosure

Aspects of the present disclosure relate to wireless communications, and more particularly, to techniques for indicating uplink resource muting.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes obtaining a configuration for a set of sounding reference signal (SRS) sets, the configuration comprising an indication of one or more SRS resources configured for at least one SRS set of the set of SRS sets; obtaining a grant for transmission of an uplink shared channel message; and sending the uplink shared channel message based at least in part on the grant, the uplink shared channel message comprising one or more muted resources that correspond to the one or more SRS resources based at least in part on the configuration.

Certain aspects provide a method for wireless communications by a network entity. The method includes sending a configuration for a set of SRS sets, the configuration comprising an indication of one or more SRS resources configured for at least one SRS set of the set of SRS sets; sending a grant for transmission of an uplink shared channel message; and obtaining the uplink shared channel message based at least in part on the grant, the uplink shared channel message comprising one or more muted resources that correspond to the one or more SRS resources based at least in part on the configuration.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across multiple computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts an example wireless communications network.

FIG. 6 depicts an example resource allocation with muted resources.

FIG. 7 depicts an example semi-static indication for triggering muted resources.

FIG. 8 depicts an example dynamic indication for triggering muted resources.

FIG. 9 depicts an example multi-slot uplink channel for triggering muted resources.

FIG. 10 depicts a process flow for communications in a network between a network entity and a UE.

FIG. 11 depicts a method for wireless communications.

FIG. 12 depicts another method for wireless communications.

FIG. 13 depicts aspects of an example communications device.

FIG. 14 depicts aspects of an example communications device.

### DETAILED DESCRIPTION

Aspects of the present disclosure provide apparatuses, methods, processing systems, and computer-readable mediums for triggering muted resources according to sounding reference signal (SRS) allocations.

A wireless communication system may include a number of devices and network entities employing techniques for exchanging information wirelessly. For example, a wireless communication system may include devices (e.g., user equipments (UEs)) and network entities (e.g., base stations (BSs)) that wirelessly communicate data, control information, reference signals, etc. (e.g., according to various wireless communication system implementations). The wireless communication system may employ various technologies to improve throughput, achieve a high data rate, and/or improve the energy efficiency of the wireless communication system. These technologies may allow a wireless communication system to support communication between an increasing number of devices and network entities, support advanced functionalities at various devices, and improve the quality of communication between devices and network entities.

In some aspects, a network entity may indicate for a UE to mute one or more uplink resources, such as uplink resource elements (REs), when the UE sends an uplink message (e.g., sent on a physical uplink shared channel (PUSCH)) to the network entity. To mute an uplink resource, the UE may refrain from sending data, signaling, and/or information in the uplink resource. The network entity may then use the muted resource to measure and/or estimate transmission non-idealities, such as interference or noise, from other signals that impact the uplink message.

The network entity may use the measured and/or estimated transmission non-idealities to adjust one or more transmission parameters to mitigate effects on communications that arise from the transmission non-idealities. For example, the network entity may perform corrections or adjustments on subsequent downlink messages sent to the UE to mitigate the measured and/or estimated transmission non-idealities. Additionally or alternatively, the network entity may indicate corrections or adjustments for the UE to apply to subsequent uplink messages sent to the network entity to mitigate the measured and/or estimated transmission non-idealities. In some aspects, the corrections or adjustments may include using a higher or lower transmission power, adjusting a modulation and coding scheme (MCS), adjusting resource allocations, etc., for sending the downlink or uplink messages.

In some aspects, when a network entity indicates for a UE to send one or more muted resources, the network entity may configure a time location configuration of uplink resource muting for a PUSCH using different possible options. For example, the network entity may semi-statically configure a position for each uplink muting symbol of up to two uplink muting symbols within a slot. In some aspects, the semi-statically configured position for each uplink muting symbol may be referred to as a single resource muting pattern. Additionally or alternatively, the network entity may semi-statically configure a value, X (where X≥1), that indicates a number of possible positions for each uplink muting symbol of the up to two uplink muting symbols within a slot. In some aspects, the number of possible positions for each uplink muting symbol may be referred to as multiple resource muting patterns. For both of these options, there will be up to two uplink muting symbols for the UE to apply resource muting when sending a PUSCH. Additionally, for the uplink resource muting symbol(s), the network entity may semi-statically configure each position of the muted symbol(s) (e.g., either for the single resource muting pattern or for the multiple resource muting patterns) and may dynamically select and indicate one resource muting pattern to the UE by a downlink control indication (DCI) message. In some aspects, for the single resource muting pattern option, the network entity may not dynamically indicate which pattern is selected in the DCI message but may dynamically activate or deactivate the single resource muting pattern via the DCI message.

Additionally, a reference point may be configured and/or defined for the UE to determine a time location of the uplink resource muting for a PUSCH. For example, the reference point may include a starting symbol of a slot for the PUSCH for both PUSCH mapping type A (e.g., the starting symbol is fixed to symbol ‘0’ of a slot for the PUSCH) and PUSCH mapping type B (e.g., the starting symbol can be flexibly configured from symbol ‘0’ to symbol ‘12’ or from symbol ‘0’ to symbol ‘13’ of a slot for the PUSCH).

One or more technical problems arise for indicating which resources are to be muted by the UE in a PUSCH. For example, the network entity may explicitly indicate one or more patterns dedicated to resource muting (e.g., resource muting patterns) to the UE, and the one or more resource muting patterns may indicate the specific resources to be muted by the UE in the up to two uplink muting symbols within a slot. However, the explicit indication of which resources to be muted may increase signaling overhead and may occupy time-frequency resources for carrying the indication that could otherwise be used for other messages and/or signaling.

The techniques and apparatuses described herein provide a technical solution for indicating muted resources for a UE to send in a PUSCH message based on resources configured and/or allocated for SRSs. For example, a network entity may configure and indicate at least one SRS set to the UE, where the SRS set includes up to two SRS resources (e.g., time-frequency resources configured for the UE to send SRSs to the network entity). However, rather than sending SRSs on the SRS resource(s) indicated for the SRS set, the UE may mute the SRS resource(s) allocated for the SRSs when sending a PUSCH message. Thus, the SRS resource(s) may be referred to as virtual SRS resource(s). In some aspects, the network entity may send the UE a grant to indicate for the UE to send a PUSCH message back to the network entity. Subsequently, the UE may send the PUSCH message to the network entity in response to receiving the grant, where the PUSCH message includes one or more muted resources corresponding to the SRS resource(s).

In some aspects, when the grant is a configured grant (CG) for a PUSCH, the network entity may indicate the one or more resources to be muted via indicating an SRS set associated with the CG and/or PUSCH, and the SRS set may indicate the SRS resource(s) that the UE is intended to mute. For example, a configuration for the CG (e.g., ConfiguredGrantConfig message) may include an indication of the SRS set, such as an identifier (ID) associated with the SRS set. Additionally or alternatively, when the grant is a dynamic grant (DG) and/or a CG that is activated by a DCI message, the network entity may indicate the one or more resources to be muted via an SRS request field included in the DCI message, where the SRS request field indicates an SRS set that includes the SRS resource(s) that the UE is intended to mute. In some aspects, the UE may apply the one or more muted resources corresponding to the SRS resource(s) for a multi-slot PUSCH (e.g., PUSCH that is sent over multiple slots, such as sending respective repetitions of the PUSCH over the multiple slots) and/or a transport block over multiple slots (TBoMS) that is scheduled or activated by a DCI message. Additionally, if the network entity configures and indicates multiple SRS sets to the UE, the network entity may indicate which SRS set and corresponding SRS resource(s) the UE is to use for the one or more muted resources via an SRS request field in a DCI message.

In certain aspects, the techniques for indicating muted resources for a UE to send in a PUSCH message based on resources configured and/or allocated for SRSs as described herein may provide any of various beneficial effects and/or advantages. For example, signaling overhead may be decreased by using configurations of SRS sets and corresponding SRS resources already sent to the UE to indicate the one or more muted resources for the UE to apply in the PUSCH message. Additionally or alternatively, a dedicated SRS set configuration may be configured for uplink resource muting (e.g., to carry the one or more muted resources), where one or more parameters not used for uplink resource muting, such as a power control configuration, are not included in the dedicated SRS set configuration, thereby reducing signaling complexity and decoding for the dedicated SRS set configuration. Additionally, a reliability of communications between the UE and the network entity may be increased based on the network entity using measurements and/or estimations obtained via the one or more muted resources to correct and/or adjust subsequent communications with the UE. In some aspects, channel usage may be reduced based on the network entity using the SRS set configuration(s) to indicate the one or more muted resources rather than explicitly signaling dedicated resource muting pattern(s) to the UE.

Additionally, SRS resources may be an efficient way to implement uplink resource muting. For example, the SRS resources may include frequency resource(s) that are based on a comb structure with a comb-offset, and uplink resource muting may also use a comb structure or configuration (e.g., comb2 configuration). Accordingly, the comb structure for the SRS resources may match the comb structure for the uplink resource muting. Additionally, a single SRS resource can be configured flexibly to map to any symbol in a slot for an uplink resource muting symbol, which may provide more efficient channel usage based on flexibly mapping the SRS resource(s).

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

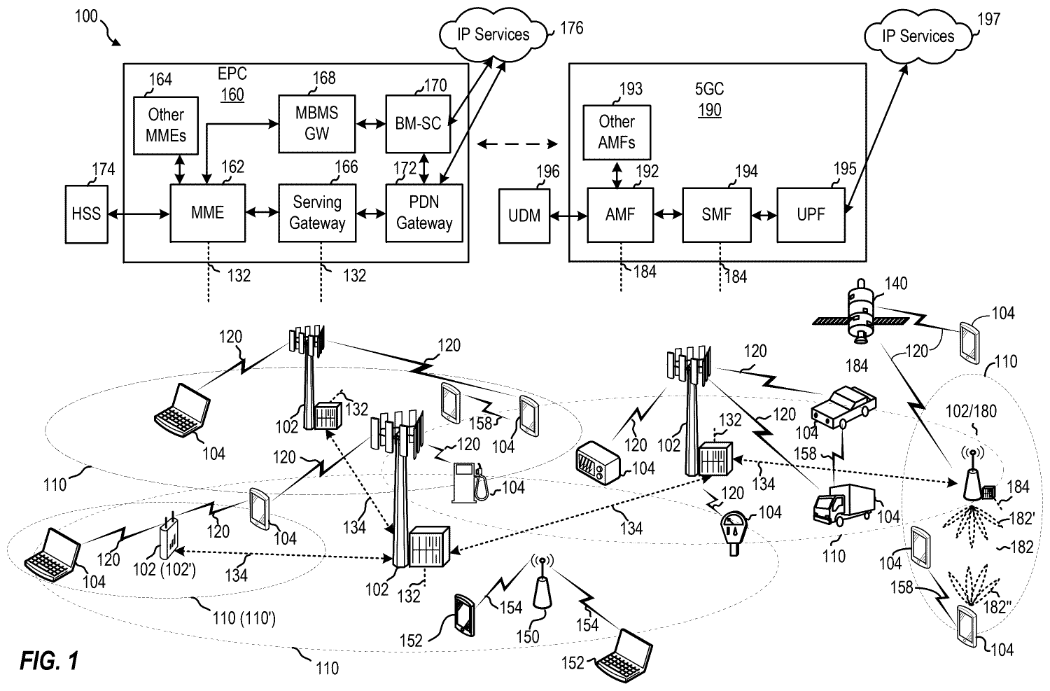

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

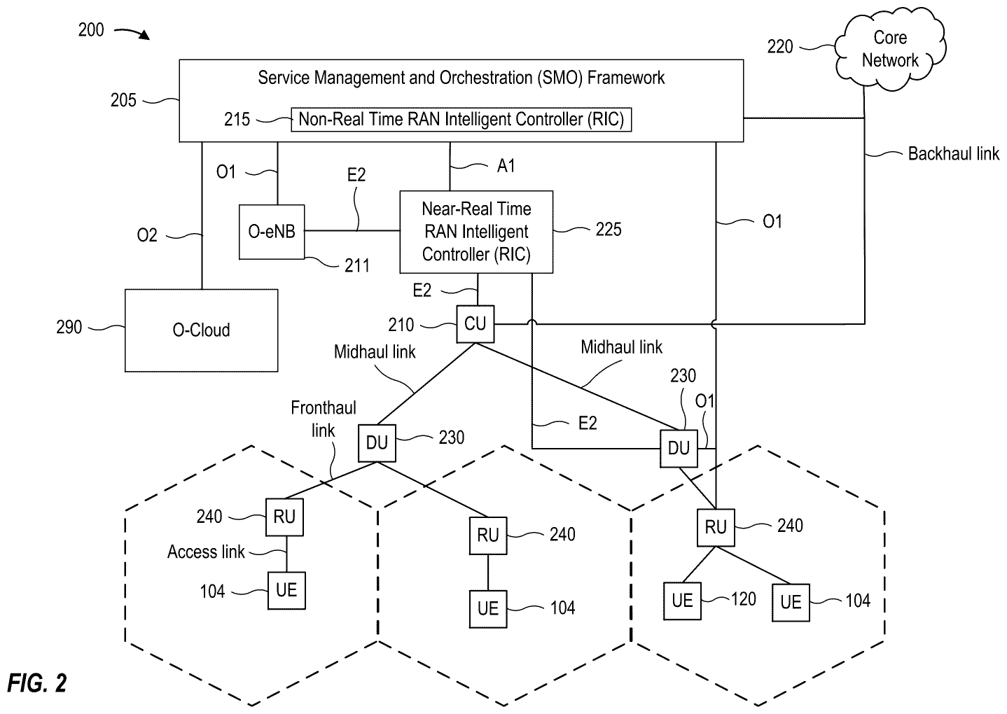

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7,125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a Wi-Fi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

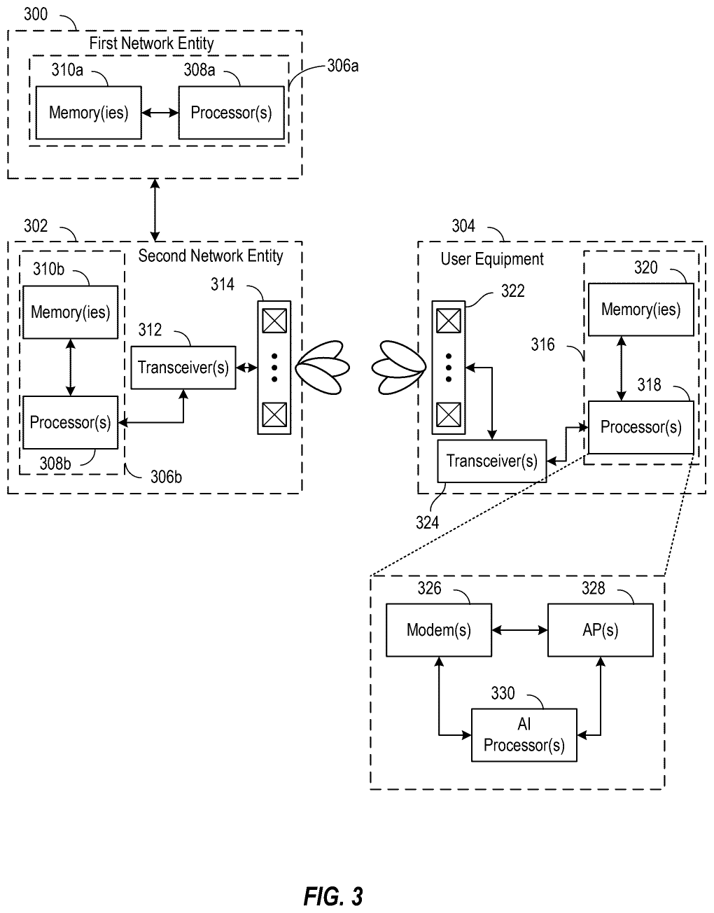

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

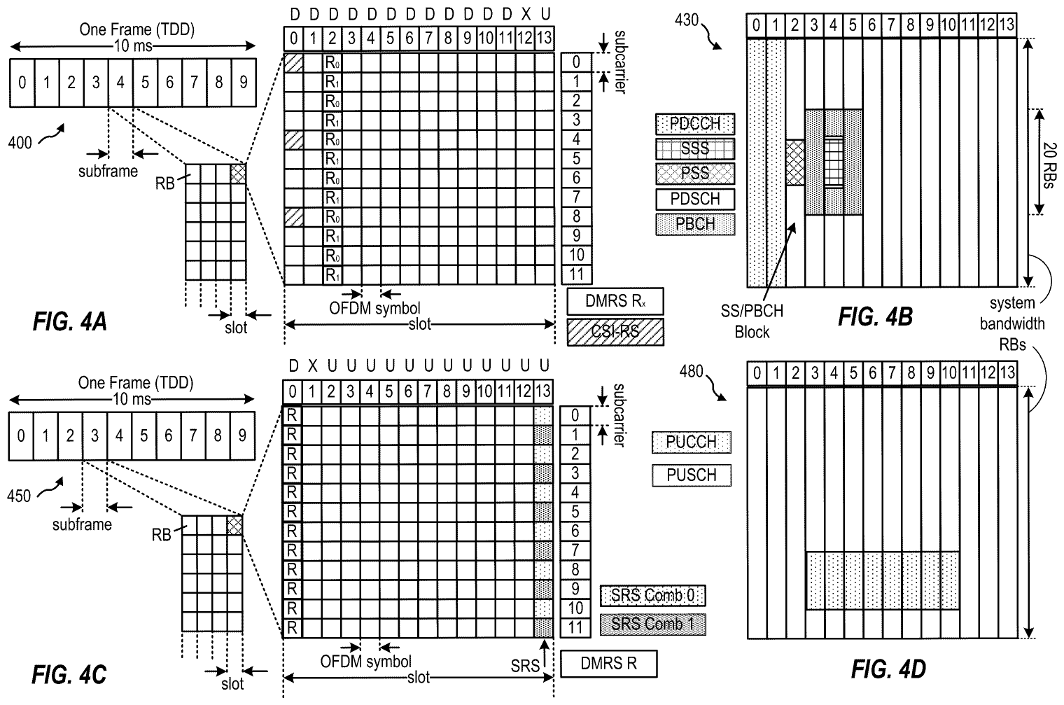

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2μ slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2\hat{ }μ×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104/304 of FIGS. 1 and 3). The RS may include a demodulation RS (DMRS) and/or a channel state information reference signal (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., UE 104/304 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Triggering Muted Resources According to SRS Allocations

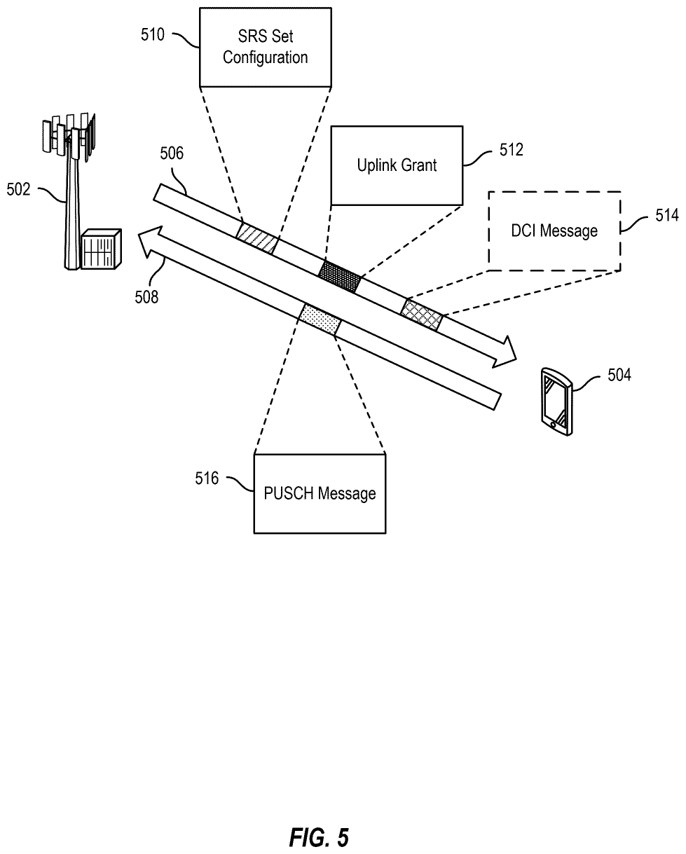

FIG. 5 depicts an example wireless communications network 500 that supports triggering muted resources in a PUSCH according to SRS allocations in accordance with aspects of the present disclosure. In some examples, the wireless communications network 500 may implement aspects of or may be implemented by aspects of FIG. 1-4. For example, the wireless communications network 500 may include a network entity 502 and a UE 504. In some aspects, the network entity 502 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 504 may be an example of the UE 104 depicted and described with respect to FIG. 1 or the UE 304 depicted and described with respect to FIG. 3. Additionally, the wireless communications network 500 may be an example of the wireless communications network 100 of FIG. 1, and may support communication between the network entity 502 and the UE 504. For example, the network entity 502 and the UE 504 may wirelessly communicate via a communication link 506 (e.g., a downlink communication link, one or more carriers, a communication link 120, etc.) and a communication link 508 (e.g., an uplink communication link, one or more carriers, a communication link 120, etc.).

In some aspects, the network entity 502 may send an SRS set configuration 510 to the UE 504. The SRS set configuration 510 may include configurations of one or more SRS sets. For example, the SRS set configuration 510 may include one or more SRS set configuration messages, where each of the one or more SRS set configuration messages corresponds to a respective SRS set of the one or more SRS sets. Additionally or alternatively, the SRS set configuration 510 may include a single SRS set configuration message for the one or more SRS sets. Additionally, the SRS set configuration 510 may include an indication of SRS resource(s) configured for each SRS set of the one or more SRS sets. That is, each SRS set may include or be associated with one or more configured SRS resources. In some aspects, the SRS set configuration 510 may include an indication of up to two SRS resources configured for at least one SRS set of the one or more SRS sets (e.g., up to two SRS resources per SRS set). The network entity 502 may send the SRS set configuration 510 via semi-static signaling, such as RRC signaling, an SRS configuration message (e.g., SRS-config message), and/or a PUSCH configuration message (e.g., PUSCH-config message). In some aspects, the SRS set may be referred to as an SRS resource set.

Additionally, the SRS set configuration 510 may include additional parameters for each SRS set of the one or more SRS sets. For example, the SRS set configuration 510 may include an identifier (ID) for each SRS set, an SRS resource ID list to indicate the SRS resources assigned to each SRS set, a resource type for the SRS resources assigned to the SRS set (e.g., aperiodic, periodic, or semi-persistent), and/or additional parameters not listed herein.

If the resource type is set to aperiodic, the corresponding SRS resource set may also be configured with two more parameters: an aperiodic SRS resource trigger (e.g., aperiodicSRS-ResourceTrigger parameter) and an aperiodic SRS resource trigger list (e.g., aperiodicSRS-ResourceTriggerList parameter). In some aspects, the aperiodic SRS resource trigger may include a DCI “code point” that takes an integer trigger value of ‘1,’ ‘2,’ or ‘3.’ That is, the aperiodic SRS resource trigger configured for an SRS set may assign one of the integer trigger values to the SRS set (e.g., each SRS set is tagged with a trigger value of either ‘1,’ ‘2,’ or ‘3’). Additionally, the SRS resource trigger list may include an additional list of DCI “code points” with an array of two parameters, such as a first parameter that includes the integer trigger value of ‘1,’ ‘2,’ or ‘3’ and a second parameter that includes a list of SRS sets associated with a corresponding trigger value. That is, the SRS resource trigger list may include an indication of multiple SRS sets with respective trigger values associated with each SRS set.

In some aspects, the UE 504 may be expected to send one or more SRSs according to SRS resource(s) of a corresponding SRS set configuration indicated in the aperiodic SRS resource trigger and/or the aperiodic SRS resource trigger list based on receiving an aperiodic SRS triggering mechanism. For example, the aperiodic SRS triggering mechanism may include an SRS request field sent in a downlink or uplink DCI message to the UE 504 by the network entity 502. The SRS request field may include two bits to indicate one of the trigger values described above. For example, if the SRS request field is ‘00,’ then no SRS set may be triggered. If the SRS request field is ‘01,’ then an SRS set associated with the trigger value of ‘1’ in the aperiodic SRS resource trigger and/or the aperiodic SRS resource trigger list may be triggered. If the SRS request field is ‘10,’ then an SRS set associated with the trigger value of ‘2’ in the aperiodic SRS resource trigger and/or the aperiodic SRS resource trigger list may be triggered. If the SRS request field is ‘11,’ then an SRS set associated with the trigger value of ‘3’ in the aperiodic SRS resource trigger and/or the aperiodic SRS resource trigger list may be triggered. “Triggering an SRS set,” as described in the context of the present disclosure, may indicate that the UE 504 is expected to send one or more SRSs on SRS resource(s) configured for the triggered SRS set.

Typically, the network entity 502 may indicate for the UE 504 to send SRSs to the network entity 502 to enable the network entity 502 to derive a channel quality, such as of the communication link 508, using the SRSs. For example, the network entity 502 may perform an uplink channel quality estimation using the SRSs based on the SRSs including predefined reference signals with known or configured characteristics by the network entity 502 and the network entity 502 then determining how the reference signals received at the network entity 502 differ from the known or configured characteristics. Subsequently, the network entity 502 may adjust one or more parameters for subsequent communications based on how the received reference signals differ from the known or configured characteristics. For example, the network entity 502 may adjust frequency resources allocated for the subsequent communications to a different frequency band if an uplink channel quality estimation derived from the SRSs indicates a frequency band that is used to carry the SRSs has a poor channel quality (e.g., if characteristics of the received reference signals differ from the known or configured characteristics by a large amount).

However, in some cases, it may be beneficial for the network entity 502 to derive other channel conditions than the channel quality estimation, such as transmission non-idealities including interference or noise that arise from other transmitted signals. For example, the channel quality estimation derived from the SRSs may not include or indicate those transmission non-idealities, or these transmission non-idealities may be easier to derive in the absence of SRS transmission or other communication by the UE 504. In some aspects, the network entity 502 may indicate for the UE 504 to send one or more muted resources for the network entity 502 to derive the transmission non-idealities as described previously. For example, the transmission non-idealities may be derived using the one or more muted resources based on the one or more muted resources not including any data, signaling, or information (e.g., the one or more muted resources are “empty” resources), such that the transmission non-idealities are identified as the main factors that affect the muted resource(s).

Accordingly, in accordance with aspects of the present disclosure, the network entity 502 may indicate for the UE 504 to send the one or more muted resources in a PUSCH based on configured SRS set(s) and corresponding SRS resources. That is, the network entity 502 may indicate for the UE 504 to send the one or more muted resources on configured SRS resources rather than sending SRSs on the configured SRS resources. For example, the network entity 502 may send an uplink grant 512 to the UE 504 (e.g., via the communication link 506), where the uplink grant 512 indicates for the UE 504 to send a PUSCH message 516 to the network entity 502 (e.g., via the communication link 508).

In some aspects, the uplink grant 512 may include a CG-Type 1, a CG-Type 2, or a DG for the PUSCH message 516. The CG-Type 1 and the CG-Type 2 may include semi-static signaling (e.g., RRC signaling) that configures one or more parameters for the PUSCH message 516. For the CG-Type 1, the network entity 502 may configure a resource allocation (or multiple resource allocations) for the PUSCH message 516 in the semi-static signaling, and the UE 504 may be expected to send the PUSCH message 516 in the resource allocation(s) after the CG-Type 1 is processed. For the CG-Type 2, the network entity 502 may partially configure parameters for the PUSCH message 516, such as a periodicity and a number of repetitions, via the semi-static signaling. The network entity 502 may then send a DCI message 514 (e.g., dynamic signaling) to indicate the resource allocation(s) and/or other parameters for the PUSCH message 516, where the UE 504 is expected to send the PUSCH message 516 in the resource allocation(s) after receiving the DCI message 514. For the DG, the network entity 502 may indicate all the parameters for the PUSCH message 516 via dynamic signaling (e.g., DCI message(s)), and the UE 504 may be expected to send the PUSCH message 516 using the parameters indicated in the dynamic signaling.

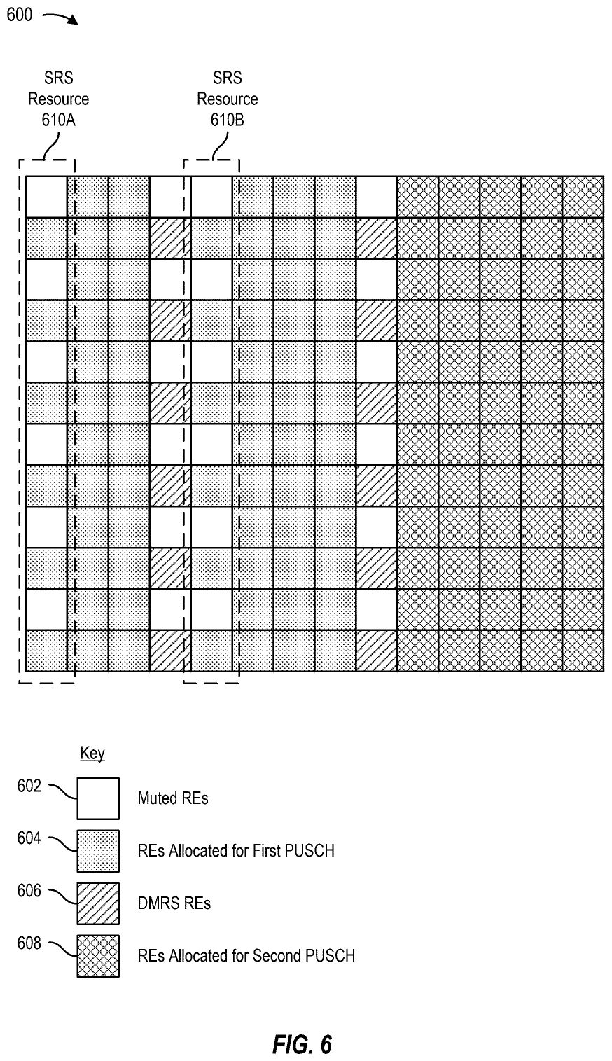

Subsequently, the UE 504 may send the PUSCH message 516 to the network entity 502 after receiving the uplink grant 512, where the PUSCH message 516 includes the one or more muted resources on SRS resource(s) originally allocated for SRS(s). In some aspects, the SRS resource(s) may be referred to as virtual SRS resource(s) based on the SRS(s) not being sent on the SRS resource(s). Additionally, the virtual SRS resource(s) to be used for the one or more muted resources may be referred to as a resource muting pattern. A resource allocation for the PUSCH message 516 that includes the one or more muted resources sent on the virtual SRS resource(s) allocated for SRS(s) is described in greater detail with reference to FIG. 6. In some aspects, the UE 504 may send the one or more muted resources on the virtual SRS resource(s) in the PUSCH message 516 rather than the SRS(s) based on a semi-static indication and/or a dynamic indication sent by the network entity 502.

In some aspects, for the semi-static indication to send the one or more muted resources on the virtual SRS resource(s) in the PUSCH message 516, the network entity 502 may associate an SRS set (e.g., indicated in the SRS set configuration 510) with the uplink grant 512 when the uplink grant 512 is a CG-Type 1 or CG-Type 2. For example, a configuration for the uplink grant 512 (e.g., ConfiguredGrantConfig message) may include an indication of the SRS set, such as an RRC parameter in the configuration for the uplink grant 512 that indicates an ID configured for the SRS set and/or IDs of the corresponding SRS resource(s) of the SRS set. Accordingly, the UE 504 may send the PUSCH message 516 with the one or more muted resources using virtual SRS resource(s) configured for the associated SRS set after receiving the uplink grant 512. That is, each SRS resource configured for the associated SRS set (e.g., virtual SRS resource(s)) may indicate one or more time-frequency resources (e.g., time location, symbols, frequency resources, subcarriers, etc.) for the one or more muted resources.

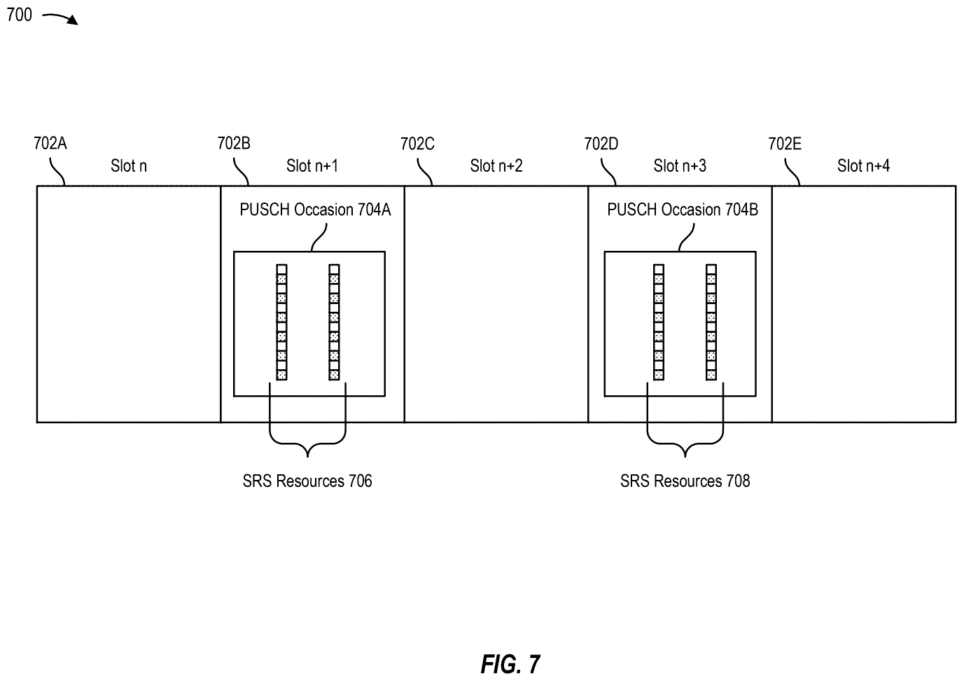

In some aspects, the UE 504 may apply the one or more muted resources when sending one or more PUSCH messages (e.g., including the PUSCH message 516) in each PUSCH occasion on the time-frequency resources indicated by the virtual SRS resources. Additionally or alternatively, the UE 504 may apply the one or more muted resources when sending one or more PUSCH messages (e.g., including the PUSCH message 516) when a PUSCH occasion overlaps with a slot that includes the virtual SRS resources. For example, the associated SRS set may include a configuration of periodic SRS resource(s) that occur in a plurality of slots according to a configured periodicity. Accordingly, when a PUSCH occasion overlaps with a slot of the plurality of slots configured for the periodic SRS resource(s), the UE 504 may apply the muted resources when sending a corresponding PUSCH message in that slot. The semi-static indication is described in greater detail with reference to FIG. 7.

Additionally or alternatively, for the dynamic indication to apply the one or more muted resources on the virtual SRS resource(s) in the PUSCH message 516, the network entity 502 may indicate an SRS set and corresponding virtual SRS resource(s) (e.g., from the SRS set configuration 510) for the UE 504 to use for the one or more muted resources when the uplink grant is a CG-Type 2 or a DG. For example, the CG-Type 2 or DG may be activated by a DCI message as described previously, and the DCI message may include an SRS request field, where the SRS request field is used to indicate the SRS set. In some aspects, the DCI message may include a DCI format 0_1 or DCI format 0_2. Subsequently, the UE 504 may apply the one or more muted resources when sending the PUSCH message 516 using the virtual SRS resource(s) of the SRS set triggered by the SRS request field. In some aspects, the SRS request field may be used to indicate a specific SRS set and corresponding SRS resource(s) to use for the one or more muted resources if multiple SRS sets are configured for the UE 504 (e.g., in the SRS set configuration 510).

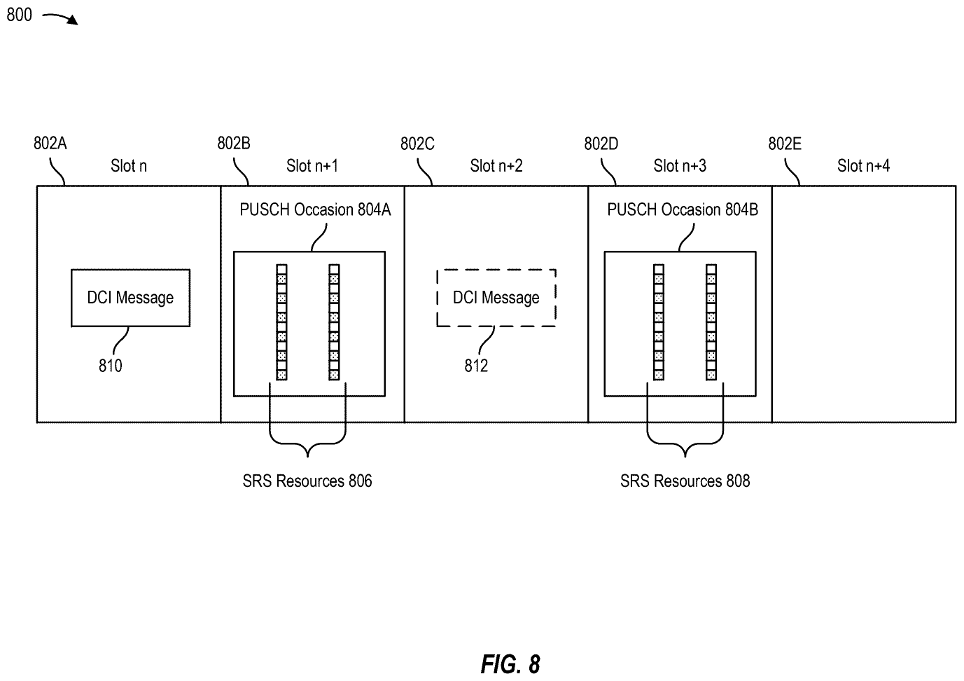

In some aspects, the UE 504 may apply the one or more muted resources on the virtual SRS resource(s) of the SRS set triggered by the SRS request field for one or more PUSCHs scheduled by the uplink grant 512. Additionally or alternatively, the UE 504 may apply the one or more muted resources on the virtual SRS resource(s) of the SRS set triggered by the SRS request field for one or more scheduled PUSCHs by respective uplink grant(s) until the UE 504 receives a second DCI message with an SRS request field that indicates a different SRS set and corresponding virtual SRS resource(s) (e.g., a different resource muting pattern). In some aspects, the DG for the PUSCH message 516 may refer to a single slot PUSCH or a multiple slot PUSCH or multiple PUSCHs scheduled by a single DCI message. Additionally, if a single SRS set and corresponding SRS resource(s) are configured in the SRS set configuration 510, then a configuration for the PUSCH message 516 (e.g., PUSCH-config message) may be associated and/or configured with the SRS resource(s) to be used for the one or more muted resources. The dynamic indication is described in greater detail with reference to FIG. 8.

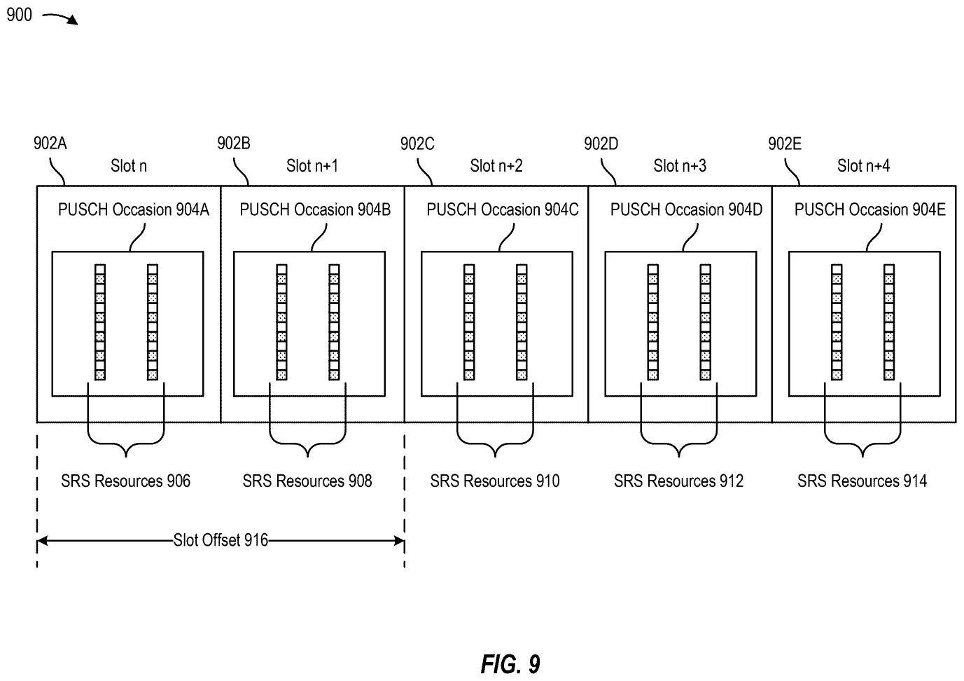

In some aspects, the UE 504 may apply the one or more muted resources for a multiple slot PUSCH. For example, for a multiple slot PUSCH (e.g., PUSCH repetition Type A) and/or for a TBoMS scheduled and/or activated by a DCI message, the UE 504 may apply the one or more muted resources on virtual SRS resource(s). In some aspects, the UE 504 may apply the one or more muted resources for all slots of a PUSCH transmission on the same time-frequency resources (e.g., OFDM symbols and/or resource elements) indicated by the virtual SRS resource(s). Additionally or alternatively, the UE 504 may apply the one or more muted resources in one or more PUSCH messages using the virtual SRS resource(s) in a slot indicated by a slot offset configured for the SRS set that includes the virtual SRS resource(s) and/or indicated by an available slot offset. The multiple slot PUSCH is described in greater detail with reference to FIG. 9.

In some aspects, the network entity 502 may indicate for the UE 504 to switch between sending SRS(s) on SRS resource(s) and using the SRS resource(s) for the one or more muted resources. For example, the network entity 502 may dynamically indicate whether the UE 504 is expected to send SRS(s) on SRS resource(s) or use the SRS resource(s) for the one or more muted resources using the SRS request field in the uplink or downlink DCI message. In some aspects, the network entity 502 may configure an SRS set with multiple trigger values, where one of the trigger values (e.g., a first code point) is specific for the virtual SRS resource(s) to be used for the one or more muted resources (i.e., an indication of the resources to be muted). As an example, the network entity 502 may configure an SRS set with an aperiodic SRS resource trigger value equal to ‘1’ and an aperiodic SRS resource trigger list value equal to ‘2’. Subsequently, if the SRS request field includes a value of ‘01’ (e.g., corresponding to the aperiodic SRS resource trigger value of ‘1’), then the UE 504 may use virtual SRS resource(s) of an SRS set indicated in the SRS request field for the one or more muted resources. Additionally or alternatively, if the SRS request field includes a value of ‘10’ (e.g., corresponding to the aperiodic SRS resource trigger list value of ‘2’), then the UE 504 may use SRS resource(s) of an SRS set indicated in the SRS request field for sending SRS(s).

Additionally or alternatively, the network entity 502 may configure an SRS set with an additional RRC parameter (e.g., aperiodicSRS-ResourceTrigger-RM parameter) that is used to trigger and/or indicate virtual SRS resource(s) configured for the SRS set for the one or more muted resources. Accordingly, if the uplink grant 512 is associated with this SRS set and/or an SRS request field indicates this SRS set, then the UE 504 may send one or more PUSCH messages using the one or more muted resources on virtual SRS resource(s) configured for this SRS set. Additionally or alternatively, the network entity 502 may configure a specific or dedicated SRS set and/or corresponding virtual SRS resource(s) to be used for the one or more muted resources. Accordingly, if the network entity 502 wants the UE 504 to send the one or more muted resources, then the network entity 502 may indicate the specific or dedicated SRS set and/or corresponding virtual SRS resource(s) to the UE 504 (e.g., in the uplink grant 512, a PUSCH configuration message, SRS request field, etc.).

In some aspects, the wireless communications network 500 may provide a framework for indicating time resources (e.g., symbols) and frequency resources (e.g., bandwidth and/or offset value) of the one or more muted resources via the virtual SRS resource(s). Additionally, the signaling and techniques described with reference to the wireless communications network 500 may define an association between PUSCH resources and aperiodic, periodic, or semi-persistent SRS resource(s) and/or SRS set(s). Additionally, the signaling and techniques described with reference to the wireless communications network 500 may support dynamically switching between SRS sets and corresponding virtual SRS resource(s) for the one or more muted resources via DCI messages (e.g., indicated via SRS request field). Additionally, the signaling and techniques described with reference to the wireless communications network 500 may support a differentiation between sending SRS(s) on SRS resource(s) (e.g., triggering SRS-MIMO) and using the SRS resource(s) for the one or more muted resources.

FIG. 6 depicts an example resource allocation 600 with muted resources in accordance with aspects of the present disclosure. In some examples, the resource allocation 600 may implement aspects of or may be implemented by aspects of FIG. 1-5. For example, a UE may send a PUSCH message with one or more muted resources according to the resource allocation 600. Additionally, the resource allocation 600 may represent a resource grid as depicted and described with reference to FIG. 4A-4D, where the resource grid for the resource allocation 600 is divided into multiple individual grid squares that represent respective REs. For example, the respective REs may include a single subcarrier in the frequency domain and a single symbol in the time domain. In the example of FIG. 6, the resource allocation 600 includes one or more muted REs 602, one or more REs 604 allocated for a first PUSCH, one or more DMRS REs 606, and one or more REs 608 allocated for a second PUSCH.

As described with reference to FIG. 5, a network entity may configure the UE with one or more SRS sets (e.g., the SRS set configuration 510), where each SRS set includes one or more configured SRS resources. For example, the network entity may indicate an SRS set configuration to the UE, where the SRS set includes a first SRS resource 610A (e.g., SRS resource 1) and a second SRS resource 610B (e.g., SRS resource 2). Accordingly, the UE may send the PUSCH message with the one or more muted resources, where the one or more muted resources correspond to (e.g., are defined by) the first SRS resource 610A and the second SRS resource 610B. That is, the UE may send the one or more muted resources (e.g., using muted REs 602) on REs allocated for transmission of SRS(s) in the first SRS resource 610A and the second SRS resource 610B.

In some aspects, the resource allocation 600 may include additional muted REs 602 than the muted REs 602 for the one or more muted resources. For example, symbols configured to include the one or more DMRS REs 606 may also include muted REs 602, but these muted REs 602 may not be associated with the SRS resources 610 (the first SRS resource 610A and/or the second SRS resource 610B). In some aspects, the muted REs 602 allocated on the same symbols as the one or more DMRS REs 606 may be configured by the network entity via other configuration message(s), such as configuration message(s) for DMRSs and/or a separate configuration message.

### Example Implementations for Triggering Muted Resources According to SRS Allocations

FIG. 7 depicts an example slot configuration 700 for a semi-static indication for triggering muted resources in accordance with aspects of the present disclosure. In some examples, the slot configuration 700 may implement aspects of or may be implemented by aspects of FIG. 1-6. For example, a UE may send a PUSCH message with one or more muted resources according to the slot configuration 700 based on a semi-static indication as described with reference to FIG. 5. In the example of FIG. 7, the slot configuration 700 may include a plurality of slots 702, such as a first slot 702A (e.g., slot), a second slot 702B (e.g., slot n+1), a third slot 702C (e.g., slot n+2), a fourth slot 702D (e.g., slot n+3), and a fifth slot 702E (e.g., slot n+4). Additionally, one or more of the slots 702 may include PUSCH occasions (e.g., configured time-frequency resources that are available for sending PUSCH messages), such as a first PUSCH occasion 704A in the second slot 702B and a second PUSCH occasion 704B in the fourth slot 702D.

As described with reference to FIG. 5 for the semi-static indication, the UE may apply the one or more muted resources when sending one or more PUSCH messages in each PUSCH occasion 704 (first PUSCH occasion 704A or second PUSCH occasion 704B) on time-frequency resources indicated by virtual SRS resource(s). For example, the UE may send PUSCH message(s) that include the one or more muted resources in the first PUSCH occasion 704A using time-frequency resources indicated by one or more SRS resources 706 and in the second PUSCH occasion 704B using time-frequency resources indicated by one or more SRS resources 708. In this example, the one or more SRS resources 706 and the one or more SRS resources 708 may be same SRS resource(s) of an SRS set, where the SRS set is associated with the PUSCH message(s) (e.g., indicated in uplink grant(s) scheduling the PUSCH message(s) and/or in a PUSCH configuration message).

Additionally or alternatively, as described with reference to FIG. 5 for the semi-static indication, the UE may apply the one or more muted resources when sending one or more PUSCH messages when a PUSCH occasion 704 overlaps with a slot 702 that includes the virtual SRS resources. As an example, the network entity may associate an SRS set with a PUSCH message, where the SRS set includes the one or more SRS resources 708 that are allocated in the fourth slot 702D. Accordingly, the UE may send the PUSCH message with the one or more muted resources corresponding to the one or more SRS resources 708 in the second PUSCH occasion 704B based on the second PUSCH occasion 704B overlapping with the fourth slot 702D that includes the one or more SRS resources 708.

FIG. 8 depicts an example slot configuration 800 for a dynamic indication for triggering muted resources in accordance with aspects of the present disclosure. In some examples, the slot configuration 800 may implement aspects of or may be implemented by aspects of FIG. 1-6. For example, a UE may send a PUSCH message with one or more muted resources according to the slot configuration 800 based on a dynamic indication as described with reference to FIG. 5. In the example of FIG. 8, the slot configuration 800 may include a plurality of slots 802, such as a first slot 802A (e.g., slot n), a second slot 802B (e.g., slot n+1), a third slot 802C (e.g., slot n+2), a fourth slot 802D (e.g., slot n+3), and a fifth slot 802E (e.g., slot n+4). Additionally, one or more of the slots 802 may include PUSCH occasions (e.g., configured time-frequency resources that are available for sending PUSCH messages), such as a first PUSCH occasion 804A in the second slot 802B and a second PUSCH occasion 804B in the fourth slot 802D.

As described with reference to FIG. 5 for the dynamic indication, a DCI message 810 may be used to activate a CG-Type 2 or DG, and the DCI message 810 may include an SRS request field to indicate an SRS set and corresponding SRS resource(s) to be used for the one or more muted resources. In some aspects, the UE may apply the one or more muted resources on virtual SRS resource(s) of the SRS set triggered by the SRS request field for one or more PUSCHs scheduled by an uplink grant. In the example of FIG. 8, the uplink grant may indicate for the UE to send a PUSCH message in the first PUSCH occasion 804A, and the SRS request field of the DCI message 810 may indicate an SRS set that includes one or more SRS resources 806. Accordingly, the UE may apply the one or more muted resources using the one or more SRS resources 806 when sending a PUSCH message in the first PUSCH occasion 804A. In some aspects, the UE may apply the one or more muted resources using the one or more SRS resources indicated in the SRS request field of the DCI message 810 for all scheduled PUSCHs. For example, the UE may also apply the one or more muted resources using one or more SRS resources 808 when sending a PUSCH message in the second PUSCH occasion 804B, where the one or more SRS resources 808 are the same as the one or more SRS resources 806.

Additionally or alternatively, the UE may apply the one or more muted resources using the one or more SRS resources indicated in the SRS request field of the DCI message 810 until the UE receives an additional DCI message 812 that includes an SRS request field that indicates a different SRS set and corresponding SRS resource(s). For example, the additional DCI message 812 may include an SRS request field that indicates an additional SRS set that includes the one or more SRS resources 808, where the additional SRS set and the one or more SRS resources 808 are different than the SRS set and the one or more SRS resources 806 indicated in the SRS request field of the DCI message 810. Accordingly, the UE may apply the one or more muted resources using the one or more SRS resources 808 when sending a PUSCH message in the second PUSCH occasion 804B.

FIG. 9 depicts an example slot configuration 900 for a multi-slot uplink channel for triggering muted resources in accordance with aspects of the present disclosure. In some examples, the slot configuration 900 may implement aspects of or may be implemented by aspects of FIG. 1-8. For example, a UE may send a PUSCH message with one or more muted resources according to the slot configuration 900 for a multiple slot PUSCH as described with reference to FIG. 5. In the example of FIG. 9, the slot configuration 900 may include a plurality of slots 902, such as a first slot 902A (e.g., slot n), a second slot 902B (e.g., slot n+1), a third slot 902C (e.g., slot n+2), a fourth slot 902D (e.g., slot n+3), and a fifth slot 902E (e.g., slot n+4). Additionally, one or more of the slots 902 may include PUSCH occasions (e.g., configured time-frequency resources that are available for sending PUSCH messages), such as a first PUSCH occasion 904A in the first slot 902A, a second PUSCH occasion 904B in the second slot 902B, a third PUSCH occasion 904C in the third slot 902C, a fourth PUSCH occasion 904D in the fourth slot 902D, and a fifth PUSCH occasion 904E in the fifth slot 902E. In some aspects, multiple PUSCH occasions 904 (first PUSCH occasion 904A, second PUSCH occasion 904B, third PUSCH occasion 904C, fourth PUSCH occasion 904D, and/or fifth PUSCH occasion 904E) may be used for a same PUSCH transmission, such as for repetitions of the PUSCH transmission or for multiple transport blocks carrying the PUSCH transmission.

As described with reference to FIG. 5 for a multiple slot PUSCH and/or for a TBoMS scheduled and/or activated by a DCI message, the UE may apply the one or more muted resources for all slots 902 of a PUSCH transmission on the same time-frequency resources indicated by the virtual SRS resource(s). For example, the UE may apply the one or more muted resources for PUSCH message(s) in respective PUSCH occasions 904 of the first slot 902A according to one or more SRS resources 906, the second slot 902B according to one or more SRS resources 908, the third slot 902C according to one or more SRS resources 910, the fourth slot 902D according to one or more SRS resources 912, and the fifth slot 902E according to one or more SRS resources 914. In this example, the one or more SRS resources 906, the one or more SRS resources 908, the one or more SRS resources 910, the one or more SRS resources 912, and the one or more SRS resources 914 may be same virtual SRS resource(s).

Additionally or alternatively, the UE may apply the one or more muted resources in one or more PUSCH messages using the virtual SRS resource(s) in a slot indicated by a slot offset configured for the SRS set that includes the virtual SRS resource(s) and/or indicated by an available slot offset. For example, the network entity may configure an SRS set for the UE to apply the one or more muted resources, where a configuration of the SRS set includes a slot offset 916 and the one or more SRS resources 910. Accordingly, the UE may apply the one or more muted resources in a PUSCH message during the third PUSCH occasion 904C using the one or more SRS resources 910 in the third slot 902C after the slot offset 916.

### Example Signaling of SRS Set Configuration(s) for Triggering Muted Resource(s)

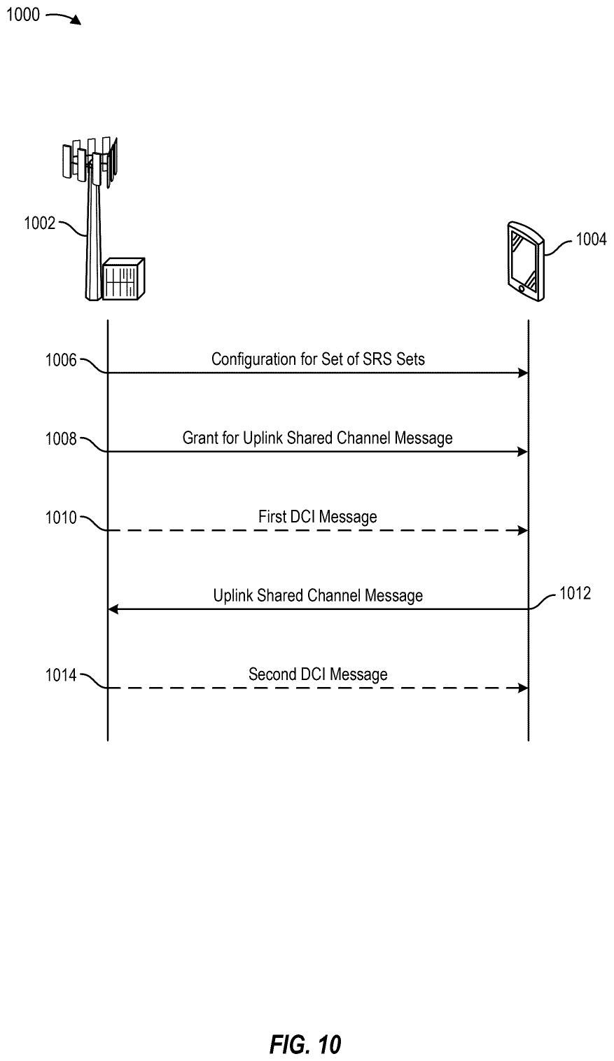

FIG. 10 depicts a process flow 1000 for communications in a wireless communications network between a network entity 1002 and a UE 1004 to enable triggering muted resources based on SRS set configuration(s) in accordance with aspects of the present disclosure. In some aspects, the network entity 1002 may be an example of the BS 102 depicted and described with respect to FIG. 1, the first network entity 300 or the second network entity 302 depicted and described with respect to FIG. 3, a disaggregated base station depicted and described with respect to FIG. 2, or the network entity 502 depicted and described with respect to FIG. 5. Similarly, the UE 1004 may be an example of UE 104 depicted and described with respect to FIG. 1, the UE 304 depicted and described with respect to FIG. 3, or the UE 504 depicted and described with respect to FIG. 5. However, in other aspects, UE 1004 may be another type of wireless communications device, and network entity 1002 may be another type of network entity or network node, such as those described herein. Note that any operations or signaling illustrated with dashed lines may indicate that that operation or signaling is an optional or alternative example.

At 1006, the network entity 1002 may send and the UE 1004 may obtain a configuration for a set of SRS sets (e.g., the SRS set configuration 510 as described with reference to FIG. 5). In some aspects, the configuration may include an indication of one or more SRS resources configured for at least one SRS set of the set of SRS sets. For example, the at least one SRS set is associated with a grant based on a configuration for the grant, and the one or more SRS resources configured for the at least one SRS set indicate one or more time-frequency resources for one or more muted resources. In some aspects, the at least one SRS set may be a specific or dedicated SRS set and/or corresponding SRS resource(s) for applying the one or more muted resources. In some aspects, the configuration may indicate multiple SRS sets including the set of SRS sets.

At 1008, the network entity 1002 may send and the UE 1004 may obtain a grant (e.g., the uplink grant 512 as described with reference to FIG. 5) for transmission of an uplink shared channel message (e.g., the PUSCH message 516 as described with reference to FIG. 5). In some aspects, the grant may include a CG-type 1 for the uplink shared channel message, a CG-type 2 for the uplink shared channel message, or a dynamic grant for the uplink shared channel message.

At 1010, the network entity 1002 may send and the UE 1004 may obtain a first DCI message (e.g., the DCI message 514 as described with reference to FIG. 5) that schedules the uplink shared channel message. In some aspects, the first DCI message may include a first SRS request field, and the first SRS request field may indicate the at least one SRS set. Accordingly, the one or more SRS resources configured for the at least one SRS set may indicate one or more time-frequency resources for the one or more muted resources. In some aspects, if the configuration indicates multiple SRS sets including the set of SRS sets, the DCI message may include an SRS request field that indicates the at least one SRS set. Additionally or alternatively, the at least one SRS set may include one or more trigger values indicated by the DCI message. Additionally or alternatively, the at least one SRS set may include a parameter (e.g., the RRC aperiodicSRS-ResourceTrigger-RM parameter) that indicates an SRS trigger value for transmission of the uplink shared channel message with the one or more muted resources.

At 1012, the UE 1004 may send and the network entity 1002 may obtain the uplink shared channel message based on the grant, where the uplink shared channel message includes the one or more muted resources that correspond to the one or more SRS resources based on the configuration communicated at 1006. For example, the uplink shared channel message may include one or more resource elements that are transmitted at zero energy, and the one or more resource elements may be defined by the one or more muted resources.

In some aspects and as described with reference to FIGS. 5 and 7, the uplink shared channel message may be associated with a CG, such as a CG-Type 1 or CG-Type 2 (e.g., for the grant communicated at 1008). Accordingly, for the uplink shared channel message, the UE 1004 may send and the network entity 1002 may obtain the uplink shared channel message with the one or more muted resources in each transmission occasion (e.g., PUSCH occasion) of a plurality of transmission occasions that include the one or more SRS resources. Additionally or alternatively, the UE 1004 may send and the network entity 1002 may obtain the uplink shared channel message with the one or more muted resources in one or more transmission occasions that overlap with a time occasion that includes the one or more SRS resources configured for the at least one SRS set.

In some aspects and as described with reference to FIGS. 5 and 8, the uplink shared channel message may be associated with a CG-Type 2 or DG (e.g., for the grant communicated at 1008). Accordingly, the UE 1004 may send and the network entity 1002 may obtain the uplink shared channel message with the one or more muted resources in one or more uplink shared channels scheduled by the grant. Additionally or alternatively, the UE 1004 may send and the network entity 1002 may obtain one or more uplink shared channel messages with the one or more muted resources in one or more uplink shared channels scheduled by one or more grants, where the one or more uplink shared channel messages include the uplink shared channel message.

In some aspects and as described with reference to FIGS. 5 and 9, the UE 1004 may send and the network entity 1002 may obtain the uplink shared channel message in a plurality of slots indicated by the grant. Additionally or alternatively, the UE 1004 may send and the network entity 1002 may obtain the uplink shared channel message in one or more slots indicated by the grant, where the one or more slots occur after a slot offset configured for the at least one SRS set.

At 1014, the network entity 1002 may send and the UE 1004 may obtain a second DCI message scheduling at least an additional uplink shared channel message (e.g., as described with reference to FIGS. 5 and 8). In some aspects, the second DCI message may include a second SRS request field, where the second SRS request field indicates an additional SRS set of the set of SRS sets. Additionally, one or more additional SRS resources configured for the additional SRS set indicate one or more time-frequency resources for one or more additional muted resources. Subsequently, the UE 1004 may send and the network entity 1002 may obtain, in one or more additional uplink shared channels scheduled by one or more additional grants, one or more additional uplink shared channel messages that include the one or more additional muted resources, where the one or more additional uplink shared channel messages include the additional uplink shared channel message. Thus, uplink resource muting may be applicable for all scheduled PUSCHs until the UE 1004 obtains another DCI indicating another resource muting pattern.

Note that the process flow illustrated in FIG. 10 is an example of triggering one or more muted resources in a PUSCH, and aspects of the present disclosure may be applied to triggering the one or more muted resources in the PUSCH based on SRS set configuration(s). Note that the process flow illustrated in FIG. 10 is described herein to facilitate an understanding of triggering the one or more muted resources in the PUSCH based on SRS set configuration(s), and aspects of the present disclosure may be performed in various manners via alternative or additional signaling and/or operations. In certain aspects, the operations and/or signaling of FIG. 10 may occur in an order different from that described or depicted, and various actions, operations, and/or signaling may be added, omitted, or combined.

### Example Operations of a User Equipment

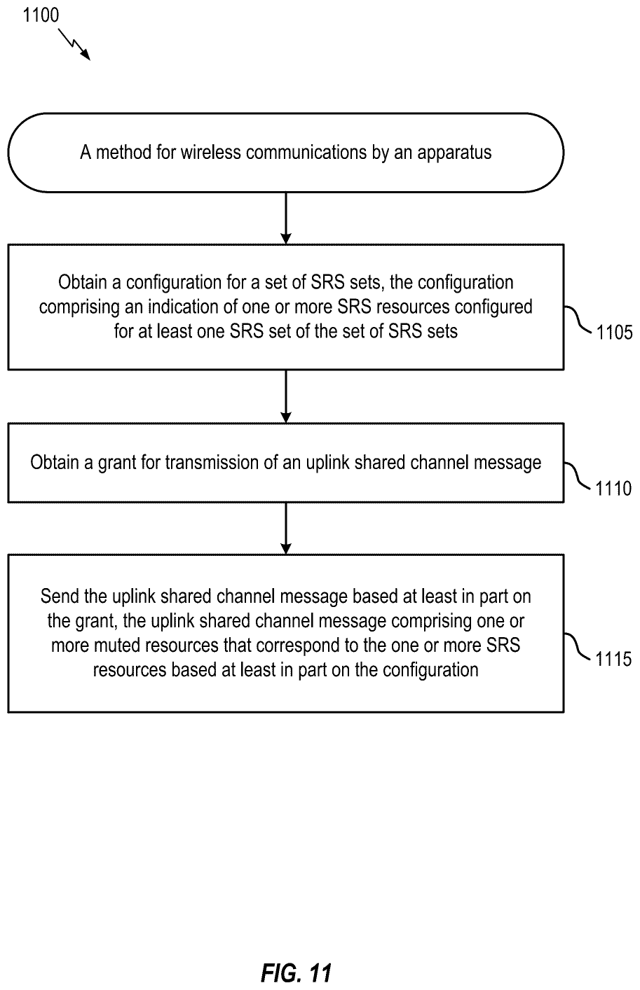

FIG. 11 shows a method 1100 for wireless communications by an apparatus, such as UE 104 of FIG. 1, UE 304 of FIG. 3, UE 504 of FIG. 5, or UE 1004 of FIG. 10.

Method 1100 begins at block 1105 with obtaining a configuration for a set of SRS sets (e.g., the SRS set configuration 510 as described with reference to FIG. 5), the configuration comprising an indication of one or more SRS resources configured for at least one SRS set of the set of SRS sets.

Method 1100 then proceeds to block 1110 with obtaining a grant (e.g., the uplink grant 512 as described with reference to FIG. 5) for transmission of an uplink shared channel message.

Method 1100 then proceeds to block 1115 with sending the uplink shared channel message (e.g., the PUSCH message 516 as described with reference to FIG. 5) based at least in part on the grant, the uplink shared channel message comprising one or more muted resources that correspond to the one or more SRS resources based at least in part on the configuration.

In some aspects, the at least one SRS set is associated with the grant based on a configuration for the grant, and the one or more SRS resources configured for the at least one SRS set indicate one or more time-frequency resources for the one or more muted resources.

In some aspects, block 1115 includes sending the uplink shared channel message with the one or more muted resources in each transmission occasion of a plurality of transmission occasions that comprise the one or more SRS resources.

In some aspects, block 1115 includes sending the uplink shared channel message with the one or more muted resources in one or more transmission occasions that overlap with a time occasion that comprises the one or more SRS resources configured for the at least one SRS set.

In some aspects, the uplink shared channel message is associated with a configured grant physical uplink shared channel.

In some aspects, method 1100 further includes obtaining a first downlink control information message (e.g., the DCI message 514 as described with reference to FIG. 5) that schedules the uplink shared channel message, the first downlink control information message comprising a first SRS request field, wherein the first SRS request field indicates the at least one SRS set, and the one or more SRS resources configured for the at least one SRS set indicate one or more time and frequency (time-frequency) resources for the one or more muted resources.

In some aspects, block 1115 includes sending the uplink shared channel message with the one or more muted resources in one or more uplink shared channels scheduled by the grant.

In some aspects, method 1100 further includes sending one or more uplink shared channel messages with the one or more muted resources in one or more uplink shared channels scheduled by one or more grants, wherein the one or more uplink shared channel messages comprise the uplink shared channel message.

In some aspects, method 1100 further includes obtaining a second downlink control information message scheduling at least an additional uplink shared channel message, the second downlink control information message comprising a second SRS request field, wherein the second SRS request field indicates an additional SRS set of the set of SRS sets, and one or more additional SRS resources configured for the additional SRS set indicate one or more time-frequency resources for one or more additional muted resources.

In some aspects, method 1100 further includes sending, in one or more additional uplink shared channels scheduled by one or more additional grants, one or more additional uplink shared channel messages comprising the one or more additional muted resources, wherein the additional one or more uplink shared channel messages comprise the additional uplink shared channel message.

In some aspects, block 1115 includes sending the uplink shared channel message in a plurality of slots indicated by the grant.

In some aspects, block 1115 includes sending the uplink shared channel message in one or more slots indicated by the grant, wherein the one or more slots occur after a slot offset configured for the at least one SRS set.

In some aspects, the configuration indicates multiple SRS sets including the set of SRS sets.

In some aspects, method 1100 further includes obtaining a downlink control information message comprising an SRS request field, wherein the SRS request field indicates the at least one SRS set.

In some aspects, the at least one SRS set comprises one or more trigger values indicated by the downlink control information message.

In some aspects, the at least one SRS set comprises a parameter that indicates an SRS trigger value for transmission of the uplink shared channel message with the one or more muted resources.

In some aspects, the grant comprises a configured grant-type 1 for the uplink shared channel message, a configured grant-type 2 for the uplink shared channel message, or a dynamic grant for the uplink shared channel message.

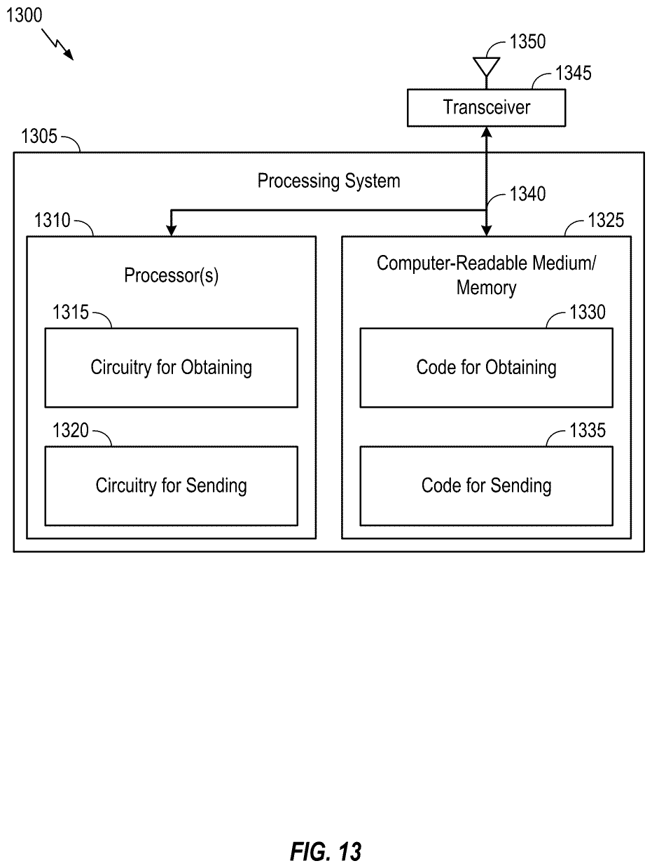

In some aspects, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative operations are possible consistent with this disclosure.

In certain aspects, method 1100 may be performed by the apparatus to realize one or more technical effects or solutions to the aforementioned technical problem(s). For example, based on method 1100, the techniques for triggering muted resources according to SRS allocations may decrease signaling overhead by using configurations of SRS sets and corresponding SRS resources already sent to the apparatus to indicate the one or more muted resources for the apparatus to apply in the uplink shared channel message (e.g., PUSCH message). Additionally, a reliability of communications between the apparatus and a network entity may be increased based on the network entity using measurements and/or estimations obtained via the one or more muted resources to correct and/or adjust subsequent communications with the apparatus. In some aspects, channel usage may be reduced based on the network entity using the SRS set configuration(s) to indicate the one or more muted resources rather than explicitly signaling dedicated resource muting pattern(s) to the apparatus.

### Example Operations of a Network Entity

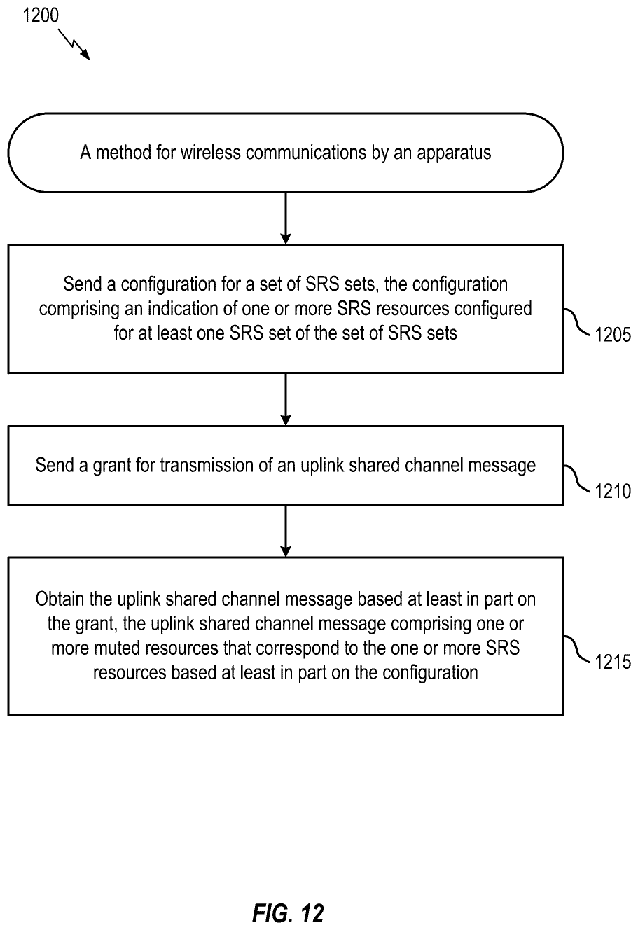

FIG. 12 shows a method 1200 for wireless communications by an apparatus, such as BS 102 of FIG. 1, a first network entity 300 or second network entity 302 of FIG. 3, a network entity 502 of FIG. 5, a network entity 1002 of FIG. 10, or a disaggregated base station as discussed with respect to FIG. 2.

Method 1200 begins at block 1205 with sending a configuration for a set of SRS sets (e.g., the SRS set configuration 510 as described with reference to FIG. 5), the configuration comprising an indication of one or more SRS resources configured for at least one SRS set of the set of SRS sets.

Method 1200 then proceeds to block 1210 with sending a grant (e.g., the uplink grant 512 as described with reference to FIG. 5) for transmission of an uplink shared channel message.

Method 1200 then proceeds to block 1215 with obtaining the uplink shared channel message (e.g., the PUSCH message 516 as described with reference to FIG. 5) based at least in part on the grant, the uplink shared channel message comprising one or more muted resources that correspond to the one or more SRS resources based at least in part on the configuration.

In some aspects, the at least one SRS set is associated with the grant based on a configuration for the grant, and the one or more SRS resources configured for the at least one SRS set indicate one or more time and frequency (time-frequency) resources for the one or more muted resources.

In some aspects, block 1215 includes obtaining the uplink shared channel message with the one or more muted resources in each transmission occasion of a plurality of transmission occasions that comprise the one or more SRS resources.

In some aspects, block 1215 includes obtaining the uplink shared channel message with the one or more muted resources in one or more transmission occasions that overlap with a time occasion that comprise the one or more SRS resources configured for the at least one SRS set.

In some aspects, the uplink shared channel message is associated with a configured grant physical uplink shared channel.

In certain aspects, method 1200 further includes sending a first downlink control information message that schedules the uplink shared channel message, the first downlink control information message comprising a first SRS request field, wherein the first SRS request field indicates the at least one SRS set, and the one or more SRS resources configured for the at least one SRS set indicate one or more time and frequency (time-frequency) resources for the one or more muted resources.

In some aspects, block 1215 includes obtaining the uplink shared channel message with the one or more muted resources in one or more uplink shared channels scheduled by the grant.

In certain aspects, method 1200 further includes obtaining one or more uplink shared channel messages with the one or more muted resources in one or more uplink shared channels scheduled by one or more grants, wherein the one or more uplink shared channel messages comprise the uplink shared channel message.

In certain aspects, method 1200 further includes sending a second downlink control information message scheduling at least an additional uplink shared channel message, the second downlink control information message comprising a second SRS request field, wherein the second SRS request field indicates an additional SRS set of the set of SRS sets and one or more SRS additional resources configured for the additional SRS set indicate one or more time-frequency resources for one or more additional muted resources.

In certain aspects, method 1200 further includes obtaining, in one or more additional uplink shared channels scheduled by one or more additional grants, one or more additional uplink shared channel messages comprising the one or more additional muted resources, wherein the one or more additional uplink shared channel messages comprise the additional uplink shared channel message.

In some aspects, block 1215 includes obtaining the uplink shared channel message in a plurality of slots indicated by the grant.

In some aspects, block 1215 includes obtaining the uplink shared channel message in one or more slots indicated by the grant, wherein the one or more slots occur after a slot offset configured for the at least one SRS set.

In some aspects, the configuration indicates multiple SRS sets including the set of SRS sets.

In certain aspects, method 1200 further includes sending a downlink control information message comprising an SRS request field, wherein the SRS request field indicates the at least one SRS set.

In some aspects, the at least one SRS set comprises one or more trigger values indicated by the downlink control information message.

In some aspects, the at least one SRS set comprises a parameter that indicates an SRS trigger value for transmission of the uplink shared channel message with the one or more muted resources.

In some aspects, the grant comprises a configured grant-type 1 for the uplink shared channel message, a configured grant-type 2 for the uplink shared channel message, or a dynamic grant for the uplink shared channel message.

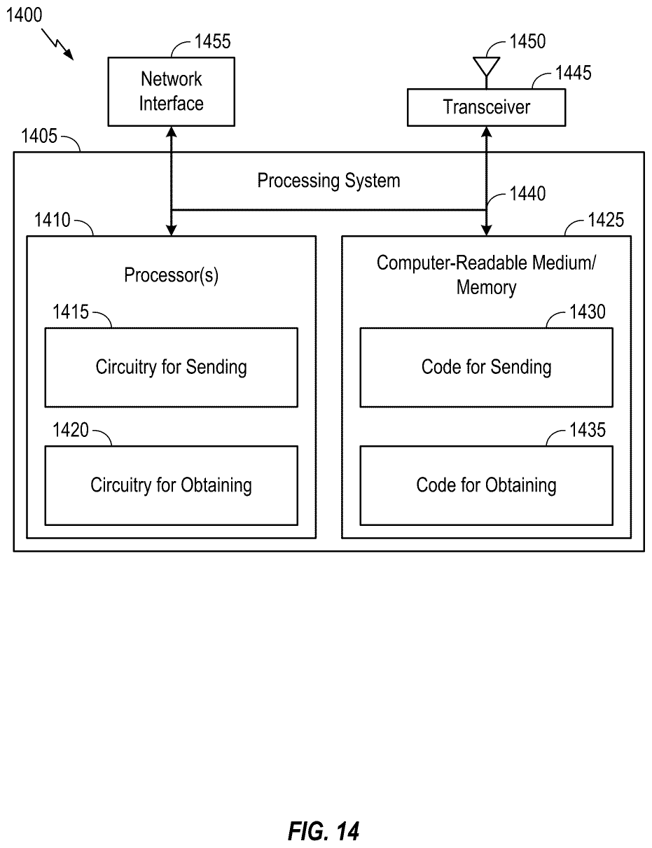

In some aspects, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative operations are possible consistent with this disclosure.

In certain aspects, method 1200 may be performed by the apparatus to realize one or more technical effects or solutions to the aforementioned technical problem(s). For example, based on method 1200, the techniques for triggering muted resources according to SRS allocations may decrease signaling overhead by using configurations of SRS sets and corresponding SRS resources already sent by the apparatus to a UE to indicate the one or more muted resources for the UE to apply in the uplink shared channel message (e.g., PUSCH message). Additionally, a reliability of communications between the UE and the apparatus may be increased based on the apparatus using measurements and/or estimations obtained via the one or more muted resources to correct and/or adjust subsequent communications with the UE. In some aspects, channel usage may be reduced based on the apparatus using the SRS set configuration(s) to indicate the one or more muted resources rather than explicitly signaling dedicated resource muting pattern(s) to the UE.

### Example Communication Devices

FIG. 13 depicts aspects of an example communications device 1300 configured for wireless communications. In some aspects, communications device 1300 is a user equipment, such as UE 104 described above with respect to FIG. 1, UE 304 described with respect to FIG. 3, UE 504 of FIG. 5, or UE 1004 of FIG. 10.

The communications device 1300 includes a processing system 1305 coupled to a transceiver 1345 (e.g., a transmitter and/or a receiver). The transceiver 1345 is configured to transmit and receive signals for the communications device 1300 via an antenna 1350, such as the various signals as described herein. The processing system 1305 may be configured to perform processing functions for the communications device 1300, including processing signals received and/or to be transmitted by the communications device 1300.

The processing system 1305 includes one or more processors 1310 and a computer-readable medium/memory 1325. In various aspects, the one or more processors 1310 may be representative of the one or more processors 318 described with respect to FIG. 3. The one or more processors 1310 are coupled to a computer-readable medium/memory 1325 via a bus 1340. In some aspects, the computer-readable medium/memory 1325 may be representative of the one or more memories 320 described with respect to FIG. 3. The computer-readable medium/memory 1325 is a non-transitory computer-readable medium/memory. In certain aspects, the computer-readable medium/memory 1325 is configured to store instructions (e.g., computer-executable code), that when executed by the one or more processors 1310, cause the one or more processors 1310 to perform the method 1100 described with respect to FIG. 11, or any aspect related to it, including any operations described in relation to FIG. 11. Note that reference to a processor performing a function of communications device 1300 may include one or more processors performing that function of communications device 1300, such as in a distributed fashion.

In the depicted example, computer-readable medium/memory 1325 stores code (e.g., executable instructions), including code for obtaining 1330 and code for sending 1335. Processing of the code 1330 and 1335 may enable and cause the communications device 1300 to perform the method 1100 described with respect to FIG. 11, or any aspect related to it.

The one or more processors 1310 include circuitry configured to implement (e.g., execute) the code stored in the computer-readable medium/memory 1325, including circuitry for obtaining 1315 and circuitry for sending 1320. Processing with circuitry 1315 and 1320 may enable and cause the communications device 1300 to perform the method 1100 described with respect to FIG. 11, or any aspect related to it.

More generally, means for communicating, transmitting, sending or outputting for transmission may include the one or more transceivers 324, one or more antenna 322 and/or processing system 316 of the UE 304 illustrated in FIG. 3, transceiver 1345 and/or antenna 1350 of the communications device 1300 in FIG. 13, and/or one or more processors 1310 of the communications device 1300 in FIG. 13. Means for communicating, receiving or obtaining may include the one or more transceivers 324, one or more antennas 322, and/or processing system 316 of the UE 304 illustrated in FIG. 3, transceiver 1345 and/or antenna 1350 of the communications device 1300 in FIG. 13, and/or one or more processors 1310 of the communications device 1300 in FIG. 13.

FIG. 14 depicts aspects of an example communications device configured for wireless communications. In some aspects, communications device 1400 is a network entity, such as BS 102 of FIG. 1, first network entity 300 or second network entity 302 of FIG. 3, a network entity 502 of FIG. 5, a network entity 1002 of FIG. 10, or a disaggregated base station as discussed with respect to FIG. 2.

The communications device 1400 includes a processing system 1405 coupled to a transceiver 1445 (e.g., a transmitter and/or a receiver) and/or a network interface 1455. The transceiver 1445 is configured to transmit and receive signals for the communications device 1400 via an antenna 1450, such as the various signals as described herein. The network interface 1455 is configured to obtain and send signals for the communications device 1400 via communications link(s), such as a backhaul link, midhaul link, and/or fronthaul link as described herein, such as with respect to FIG. 2. The processing system 1405 may be configured to perform processing functions for the communications device 1400, including processing signals received and/or to be transmitted by the communications device 1400.

The processing system 1405 includes one or more processors 1410 and a computer-readable medium/memory 1425. In various aspects, one or more processors 1410 may be representative of the one or more processors 308, as described with respect to FIG. 3. The one or more processors 1410 are coupled to the computer-readable medium/memory 1425 via a bus 1440. In certain aspects, the computer-readable medium/memory 1425 is configured to store instructions (e.g., computer-executable code), including code 1430 and 1435, that when executed by the one or more processors 1410, cause the one or more processors 1410 to perform the method 1200 described with respect to FIG. 12, or any aspect related to it, including any operations described in relation to FIG. 12. The computer-readable medium/memory 1425 is a non-transitory computer-readable medium/memory. Note that reference to a processor of communications device 1400 performing a function may include one or more processors of communications device 1400 performing that function, such as in a distributed fashion.

In the depicted example, the computer-readable medium/memory 1425 stores code (e.g., executable instructions), including code for sending 1430 and code for obtaining 1435. Processing of the code 1430 and 1435 may enable and cause the communications device 1400 to perform the method 1200 described with respect to FIG. 12, or any aspect related to it.

The one or more processors 1410 include circuitry configured to implement (e.g., execute) the code stored in the computer-readable medium/memory 1425, including circuitry for sending 1415 and circuitry for obtaining 1420. Processing with circuitry 1415 and 1420 may enable and cause the communications device 1400 to perform the method 1200 described with respect to FIG. 12, or any aspect related to it.

Various components of the communications device 1400 may provide means for performing the method 1200 described with respect to FIG. 12, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1445, antenna 1450, and/or network interface 1455 of the communications device 1400 in FIG. 14, and/or one or more processors 1410 of the communications device 1400 in FIG. 14. Means for communicating, receiving or obtaining may include the one or more transceivers 312, one or more antennas 314, and/or processing system 306 of the first network entity 300 or the second network entity 302 illustrated in FIG. 3, transceiver 1445, antenna 1450, and/or network interface 1455 of the communications device 1400 in FIG. 14, and/or one or more processors 1410 of the communications device 1400 in FIG. 14.

### Example Clauses

Implementation examples are described in the following numbered clauses:

Clause 1: A method for wireless communications by a UE comprising: obtaining a configuration for a set of SRS sets, the configuration comprising an indication of one or more SRS resources configured for at least one SRS set of the set of SRS sets; obtaining a grant for transmission of an uplink shared channel message; and sending the uplink shared channel message based at least in part on the grant, the uplink shared channel message comprising one or more muted resources that correspond to the one or more SRS resources based at least in part on the configuration.

Clause 2: The method of Clause 1, wherein: the at least one SRS set is associated with the grant based on a configuration for the grant, and the one or more SRS resources configured for the at least one SRS set indicate one or more time and frequency (time-frequency) resources for the one or more muted resources.

Clause 3: The method of Clause 2, wherein sending the uplink shared channel message comprises sending the uplink shared channel message with the one or more muted resources in each transmission occasion of a plurality of transmission occasions that comprise the one or more SRS resources.

Clause 4: The method of Clause 2, wherein sending the uplink shared channel message comprises sending the uplink shared channel message with the one or more muted resources in one or more transmission occasions that overlap with a time occasion that comprises the one or more SRS resources configured for the at least one SRS set.

Clause 5: The method of Clause 2, wherein the uplink shared channel message is associated with a configured grant physical uplink shared channel.

Clause 6: The method of any one of Clauses 1-5, further comprising obtaining a first downlink control information message that schedules the uplink shared channel message, the first downlink control information message comprising a first SRS request field, wherein the first SRS request field indicates the at least one SRS set, and the one or more SRS resources configured for the at least one SRS set indicate one or more time and frequency (time-frequency) resources for the one or more muted resources.

Clause 7: The method of Clause 6, wherein sending the uplink shared channel message comprises sending the uplink shared channel message with the one or more muted resources in one or more uplink shared channels scheduled by the grant.

Clause 8: The method of Clause 6, further comprising sending one or more uplink shared channel messages with the one or more muted resources in one or more uplink shared channels scheduled by one or more grants, wherein the one or more uplink shared channel messages comprise the uplink shared channel message.

Clause 9: The method of Clause 8, further comprising: obtaining a second downlink control information message scheduling at least an additional uplink shared channel message, the second downlink control information message comprising a second SRS request field, wherein the second SRS request field indicates an additional SRS set of the set of SRS sets, and one or more additional SRS resources configured for the additional SRS set indicate one or more additional time-frequency resources for one or more additional muted resources; and sending, in one or more additional uplink shared channels scheduled by one or more additional grants, one or more additional uplink shared channel messages comprising the one or more additional muted resources, wherein the one or more additional uplink shared channel messages comprise the additional uplink shared channel message.

Clause 10: The method of any one of Clauses 1-9, wherein sending the uplink shared channel message comprises sending the uplink shared channel message in a plurality of slots indicated by the grant.

Clause 11: The method of any one of Clauses 1-10, wherein sending the uplink shared channel message comprises sending the uplink shared channel message in one or more slots indicated by the grant, wherein the one or more slots occur after a slot offset configured for the at least one SRS set.

Clause 12: The method of any one of Clauses 1-11, wherein the configuration indicates multiple SRS sets including the set of SRS sets.

Clause 13: The method of Clause 12, further comprising obtaining a downlink control information message comprising an SRS request field, wherein the SRS request field indicates the at least one SRS set.

Clause 14: The method of Clause 13, wherein the at least one SRS set comprises one or more trigger values indicated by the downlink control information message.

Clause 15: The method of Clause 12, wherein the at least one SRS set comprises a parameter that indicates an SRS trigger value for transmission of the uplink shared channel message with the one or more muted resources.

Clause 16: The method of any one of Clauses 1-15, wherein the grant comprises a configured grant-type 1 for the uplink shared channel message, a configured grant-type 2 for the uplink shared channel message, or a dynamic grant for the uplink shared channel message.

Clause 17: A method for wireless communications by a network entity comprising: sending a configuration for a set of SRS sets, the configuration comprising an indication of one or more SRS resources configured for at least one SRS set of the set of SRS sets; sending a grant for transmission of an uplink shared channel message; and obtaining the uplink shared channel message based at least in part on the grant, the uplink shared channel message comprising one or more muted resources that correspond to the one or more SRS resources based at least in part on the configuration.

Clause 18: The method of Clause 17, wherein: the at least one SRS set is associated with the grant based on a configuration for the grant, and the one or more SRS resources configured for the at least one SRS set indicate one or more time and frequency (time-frequency) resources for the one or more muted resources.

Clause 19: The method of Clause 18, wherein obtaining the uplink shared channel message comprises obtaining the uplink shared channel message with the one or more muted resources in each transmission occasion of a plurality of transmission occasions that comprise the one or more SRS resources.

Clause 20: The method of Clause 18, wherein obtaining the uplink shared channel message comprises obtaining the uplink shared channel message with the one or more muted resources in one or more transmission occasions that overlap with a time occasion that comprise the one or more SRS resources configured for the at least one SRS set.

Clause 21: The method of Clause 18, wherein the uplink shared channel message is associated with a configured grant physical uplink shared channel.

Clause 22: The method of any one of Clauses 17-21, further comprising sending a first downlink control information message that schedules the uplink shared channel message, the first downlink control information message comprising a first SRS request field, wherein the first SRS request field indicates the at least one SRS set, and the one or more SRS resources configured for the at least one SRS set indicate one or more time and frequency (time-frequency) resources for the one or more muted resources.

Clause 23: The method of Clause 22, wherein obtaining the uplink shared channel message comprises obtaining the uplink shared channel message with the one or more muted resources in one or more uplink shared channels scheduled by the grant.

Clause 24: The method of Clause 22, further comprising obtaining one or more uplink shared channel messages with the one or more muted resources in one or more uplink shared channels scheduled by one or more grants, wherein the one or more uplink shared channel messages comprise the uplink shared channel message.

Clause 25: The method of Clause 24, further comprising: sending a second downlink control information message scheduling at least an additional uplink shared channel message, the second downlink control information message comprising a second SRS request field, wherein the second SRS request field indicates an additional SRS set of the set of SRS sets and one or more additional SRS resources configured for the additional SRS set indicate one or more additional time-frequency resources for one or more additional muted resources; and obtaining, in one or more additional uplink shared channels scheduled by one or more additional grants, one or more uplink shared channel messages comprising the one or more additional muted resources, wherein the one or more uplink shared channel messages comprise the additional uplink shared channel message.

Clause 26: The method of any one of Clauses 17-25, wherein obtaining the uplink shared channel message comprises obtaining the uplink shared channel message in a plurality of slots indicated by the grant.

Clause 27: The method of any one of Clauses 17-26, wherein obtaining the uplink shared channel message comprises obtaining the uplink shared channel message in one or more slots indicated by the grant, wherein the one or more slots occur after a slot offset configured for the at least one SRS set.

Clause 28: The method of any one of Clauses 17-27, wherein the configuration indicates multiple SRS sets including the set of SRS sets.

Clause 29: The method of Clause 28, further comprising sending a downlink control information message comprising an SRS request field, wherein the SRS request field indicates the at least one SRS set.

Clause 30: The method of Clause 28, wherein the at least one SRS set comprises one or more trigger values indicated by the downlink control information message.

Clause 31: The method of Clause 28, wherein the at least one SRS set comprises a parameter that indicates an SRS trigger value for transmission of the uplink shared channel message with the one or more muted resources.

Clause 32: The method of any one of Clauses 17-31, wherein the grant comprises a configured grant-type 1 for the uplink shared channel message, a configured grant-type 2 for the uplink shared channel message, or a dynamic grant for the uplink shared channel message.

Clause 33: One or more apparatuses, comprising: one or more memories comprising executable instructions; and one or more processors configured to execute the executable instructions and cause the one or more apparatuses to perform a method in accordance with any one of Clauses 1-32.

Clause 34: One or more apparatuses configured for wireless communications, comprising: one or more memories; and one or more processors, coupled to the one or more memories, configured to cause the one or more apparatuses to perform a method in accordance with any one of Clauses 1-32.

Clause 35: One or more apparatuses configured for wireless communications, comprising: one or more memories; and one or more processors, coupled to the one or more memories, configured to perform a method in accordance with any one of Clauses 1-32.

Clause 36: One or more apparatuses, comprising means for performing a method in accordance with any one of Clauses 1-32.

Clause 37: One or more non-transitory computer-readable media comprising executable instructions that, when executed by one or more processors of one or more apparatuses, cause the one or more apparatuses to perform a method in accordance with any one of Clauses 1-32.

Clause 38: One or more computer program products embodied on one or more computer-readable storage media comprising code for performing a method in accordance with any one of Clauses 1-32.

Clause 39: One or more apparatuses configured for wireless communications, comprising: a processing system that includes one or more processors and one or more memories coupled with the one or more processors, the processing system configured to cause the one or more apparatuses to perform a method in accordance with any one of Clauses 1-32.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining”may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus comprising a processing system, the processing system comprising one or more memories and one or more processors coupled to the one or more memories, the processing system configured to cause a user equipment (UE) to:
obtain a configuration for a set of sounding reference signal (SRS) sets, the configuration comprising an indication of one or more SRS resources configured for at least one SRS set of the set of SRS sets;
obtain a grant for transmission of an uplink shared channel message; and
send the uplink shared channel message based at least in part on the grant, the uplink shared channel message comprising one or more muted resources that correspond to the one or more SRS resources based at least in part on the configuration.

2. The apparatus of claim 1, wherein:
the at least one SRS set is associated with the grant based on a configuration for the grant, and
the one or more SRS resources configured for the at least one SRS set indicate one or more time and frequency (time-frequency) resources for the one or more muted resources.

3. The apparatus of claim 2, wherein to cause the UE to send the uplink shared channel message, the processing system is configured to cause the UE to send the uplink shared channel message with the one or more muted resources in each transmission occasion of a plurality of transmission occasions that comprise the one or more SRS resources.

4. The apparatus of claim 2, wherein to cause the UE to send the uplink shared channel message, the processing system is configured to cause the UE to send the uplink shared channel message with the one or more muted resources in one or more transmission occasions that overlap with a time occasion that comprises the one or more SRS resources configured for the at least one SRS set.

5. The apparatus of claim 2, wherein the uplink shared channel message is associated with a configured grant physical uplink shared channel.

6. The apparatus of claim 1, wherein:
the processing system is further configured to cause the UE to obtain a first downlink control information message that schedules the uplink shared channel message, the first downlink control information message comprising a first SRS request field,
the first SRS request field indicates the at least one SRS set, and
the one or more SRS resources configured for the at least one SRS set indicate one or more time and frequency (time-frequency) resources for the one or more muted resources.

7. The apparatus of claim 6, wherein to cause the UE to send the uplink shared channel message, the processing system is configured to cause the UE to send the uplink shared channel message with the one or more muted resources in one or more uplink shared channels scheduled by the grant.

8. The apparatus of claim 6, wherein the processing system is configured to cause the UE to send one or more uplink shared channel messages with the one or more muted resources in one or more uplink shared channels scheduled by one or more grants, wherein the one or more uplink shared channel messages comprise the uplink shared channel message.

9. The apparatus of claim 8, wherein the processing system is further configured to cause the UE to:
obtain a second downlink control information message scheduling at least an additional uplink shared channel message, the second downlink control information message comprising a second SRS request field, wherein the second SRS request field indicates an additional SRS set of the set of SRS sets, and one or more additional SRS resources configured for the additional SRS set indicate one or more additional time-frequency resources for one or more additional muted resources; and
send, in one or more additional uplink shared channels scheduled by one or more additional grants, one or more additional uplink shared channel messages comprising the one or more additional muted resources, wherein the one or more additional uplink shared channel messages comprise the additional uplink shared channel message.

10. The apparatus of claim 1, wherein to cause the UE to send the uplink shared channel message, the processing system is configured to cause the UE to send the uplink shared channel message in a plurality of slots indicated by the grant.

11. The apparatus of claim 1, wherein to cause the UE to send the uplink shared channel message, the processing system is configured to cause the UE to send the uplink shared channel message in one or more slots indicated by the grant, wherein the one or more slots occur after a slot offset configured for the at least one SRS set.

12. The apparatus of claim 1, wherein the configuration indicates multiple SRS sets including the set of SRS sets.

13. The apparatus of claim 12, wherein the processing system is further configured to cause the UE to obtain a downlink control information message comprising an SRS request field, wherein the SRS request field indicates the at least one SRS set.

14. The apparatus of claim 13, wherein the at least one SRS set comprises one or more trigger values indicated by the downlink control information message.

15. The apparatus of claim 12, wherein the at least one SRS set comprises a parameter that indicates an SRS trigger value for transmission of the uplink shared channel message with the one or more muted resources.

16. The apparatus of claim 1, wherein the grant comprises a configured grant-type 1 for the uplink shared channel message, a configured grant-type 2 for the uplink shared channel message, or a dynamic grant for the uplink shared channel message.

17. An apparatus comprising a processing system, the processing system comprising one or more memories and one or more processors coupled to the one or more memories, the processing system configured to cause a network entity to:
send a configuration for a set of sounding reference signal (SRS) sets, the configuration comprising an indication of one or more SRS resources configured for at least one SRS set of the set of SRS sets;
send a grant for transmission of an uplink shared channel message; and
obtain the uplink shared channel message based at least in part on the grant, the uplink shared channel message comprising one or more muted resources that correspond to the one or more SRS resources based at least in part on the configuration.

18. The apparatus of claim 17, wherein:
the at least one SRS set is associated with the grant based on a configuration for the grant, and
the one or more SRS resources configured for the at least one SRS set indicate one or more time and frequency (time-frequency) resources for the one or more muted resources.

19. The apparatus of claim 17, wherein:
the processing system is further configured to cause the network entity to send a first downlink control information message that schedules the uplink shared channel message, the first downlink control information message comprising a first SRS request field,
the first SRS request field indicates the at least one SRS set, and
the one or more SRS resources configured for the at least one SRS set indicate one or more time and frequency (time-frequency) resources for the one or more muted resources.

20. A method for wireless communications by a user equipment (UE) comprising:
obtaining a configuration for a set of sounding reference signal (SRS) sets, the configuration comprising an indication of one or more SRS resources configured for at least one SRS set of the set of SRS sets;
obtaining a grant for transmission of an uplink shared channel message; and
sending the uplink shared channel message based at least in part on the grant, the uplink shared channel message comprising one or more muted resources that correspond to the one or more SRS resources based at least in part on the configuration.
